(19) United States
(12) Patent Application Publication
(10) Pub. No.: US 2026/0274559 A1
(43) Pub. Date: Sep. 17, 2026

(54) TRASH RECEPTACLE

(71) Applicant: David Currall, Apex, NC (US)

(72) Inventor: David Currall, Apex, NC (US)

(21) Appl. No.: 19/347,945

(22) Filed: Oct. 2, 2025

Related U.S. Application Data
(60) Provisional application No. 63/771,074, filed on Mar. 13, 2025.

(51) Int. Cl. B65F 1/06; B65F 1/12; B65F 1/16

(52) U.S. Cl. CPC B65F 1/06; B65F 1/12; B65F 1/1607

(57) ABSTRACT

A trash receptacle for securing a garbage bag includes a primary body having a conical configuration portion defining a hollow interior area, and open bottom, and having a top that defines an aperture. The trash receptacle includes a drip tray positioned adjacent the open bottom and being configured to receive drippings from the garbage bag. A pair of handle members extends laterally outwardly from the top of the primary body portion and is configured to receive opposed drawstrings of the garbage bag. The trash receptacle includes an elastic band configured to secure the garbage bag to an exterior surface of the top until the body portion of the garbage bag becomes filled with refuse exceeding a predetermined weight the garbage bag is released by the elastic band and falls via gravity onto the drip tray, the fall causing the drawstrings to engage and close the garbage bag.

### REFERENCE TO RELATED APPLICATIONS

This application is a non-provisional application that claims the benefit of U.S. provisional patent application No. 63/771,074 filed Mar. 13, 2025 titled TRASH RECEPTACLE, which is incorporated herein in its entirety.

### BACKGROUND OF THE INVENTION

This invention relates generally to waste management, and more particularly, to a system for conveniently gathering and removing trash bags from public and private waste baskets.

Replacing a trash bag in a public waste basket is a universally inconvenient task. The process is fraught with annoyances, from overflowing, ripped, or tangled bags to spilled trash. Customary methods of gathering and replacing trash bags are especially frustrating, and past attempts at innovation have been similarly ineffective.

One major annoyance arises when a trash bag becomes too full, and the accumulated waste becomes excessively heavy and challenging to handle. In public spaces, where waste baskets may be large or overstuffed, personnel may struggle to loosen the bag's drawstrings from the lip of the basket or extract the bag from the container by lifting. Many bags stretch or rip under the weight of their contents, and their removal becomes a delicate operation. If the bag is too heavy or poorly secured, it may spill its contents, creating even more mess.

Additionally, there is the issue of hygiene. When people handle dirty bags, touch the inside of a waste container, or regather spilled trash, they are directly exposed to harmful germs and bacteria. The likelihood of exposure is especially high for the personnel who manage public waste baskets. Unfortunately, the current design of waste baskets does not account for this aspect of public health. For the sake of these individuals, and indeed, for anyone who is required to handle trash bags, it is essential to find a cleaner, more efficient system.

One solution to these problems would be a novel design for a trash receptacle featuring a lightweight conical body that is narrower at the top and broader at the bottom, having a flattened edge on one side (to fit flush to a surface), two handles attached on the outside at the top, and an elastic material around sidewall near the top. The bottom of the receptacle is left open, similar to an upside-down funnel, and rests in a drip tray to catch any residue from leaks. A trash bag is secured around the lip of the receptacle by the elastic material, and the bag's drawstrings are looped around the handles of the basket. Eventually, as the trash bag fills, the weight of its contents exceeds the friction of the elastic material, causing the bag to drop down into the drip tray beneath. The drawstrings automatically tighten and cinch the bag shut.

To remove the bag, a user loosens the drawstrings off the handles and removes the lightweight conical body of the trash receptacle. The trash bag is then easily collected, being no heavier than a predetermined weigh 771,074 t and already cinched shut, preventing spillage. The lightweight conical body is then replaced and a new bag inserted.

The advantages of this system are clear. First, it provides a self-cinching mechanism that minimizes the risk of spillage or tearing and prevents bags from becoming excessively heavy or overstuffed. Second, the system reduces the likelihood of exposure to germs and contaminants by eliminating the need to frequently and directly handle waste. Finally, the system saves time and energy. Rather than struggling with untangling, adjusting, and lifting heavy bags, users can quickly dispose of trash and replace bags in seconds. For this reason, the system is accessible to many (e.g. the elderly and disabled) who find traditional bag replacement cumbersome.

Therefore, it would be desirable to have a trash receptacle featuring a lightweight and gradually conical body that is narrower at the top and broader at the bottom and having an elastic material around its upper lip, whereby a garbage bag may be secured, and two handles attached on the outside at the top, around which the drawstrings of a trash bag may be placed. Furthermore, it would be desirable for the bottom of the receptacle to be left open and seated in a drip tray. Additionally, it would be desirable for the receptacle to include a flattened edge on one side in order to fit flush to a surface.

### SUMMARY OF THE INVENTION

Therefore, a trash receptacle for securing a garbage bag according to the present invention includes a primary body having a conical configuration portion defining a hollow interior area, and open bottom, and having a top that defines an aperture. The trash receptacle includes a drip tray positioned adjacent the open bottom and being configured to receive drippings from the garbage bag. A pair of handle members extends laterally outwardly from the top of the primary body portion and is configured to receive opposed drawstrings of the garbage bag. The trash receptacle includes an elastic band configured to secure the garbage bag to an exterior surface of the top until the body portion of the garbage bag becomes filled with refuse exceeding a predetermined weight the garbage bag is released by the elastic band and falls via gravity onto the drip tray, the fall causing the drawstrings to engage and close the garbage bag.

Therefore, a general object of this invention is to provide a trash receptacle in having an elastic band for securing a garbage bag to hang within its interior area, the elastic band being configured to release the garbage bag when it reaches a predetermined weight. In other words, the garbage bag is released by the elastic band to fall when it becomes filled with a predetermined weight of refuse.

Another object of this invention is to provide a trash receptacle, as aforesaid, having a pair of outwardly and laterally extending handles about which corresponding drawstrings of the garbage bag may be secured such that the drawstrings are engaged automatically to tighten and close the garbage bag when the garbage bag is released to fall.

Still another object of this invention is to provide a trash receptacle, as aforesaid, that includes a drip tray positioned adjacent an open bottom, the drip tray being configured to receive drippings from the garbage bag being held by the elastic band and also being configured to receive the garbage bag itself when it is released to fall.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a trash receptacle according to the present invention;

FIG. 1b is another perspective view taken from reverse angle of the trash receptacle as in FIG. 1a;

FIG. 1c is an exploded view of the trash receptacle as in FIG. 1a;

FIG. 2a is another perspective view of the trash receptacle as in FIG. 1a;

FIG. 2b is an isolated view on an enlarged scale taken from FIG. 2a;

FIG. 3 is an exploded view of the trash receptacle as in FIG. 1a;

FIG. 4a is a perspective view of the trash receptacle as in FIG. 1a;

FIG. 4b is a sectional view taken along line 4b-4b of FIG. 4a;

FIG. 4c is an isolated view on an enlarged scale taken from FIG. 4b;

FIG. 5 is a perspective view of the trash receptacle as in FIG. 4a, illustrated with the triggering handles being engaged to close the garbage bag;

FIG. 6a is a side view of the trash receptacle as in FIG. 5; and

FIG. 6b is a sectional view taken along line 6b-6b of FIG. 6a.

### DESCRIPTION OF THE PREFERRED EMBODIMENT

A trash receptacle according to a preferred embodiment of the present invention will now be described with reference to the accompanying drawings. The trash receptacle 10 includes a primary body portion 20 and a drip tray 30 for receiving a garbage bag and then automatically closing and dropping the garbage bag 100 when it becomes filled with refuse. The trash receptacle 10 may include a primary body portion 20 and a drip tray 30. The primary body portion 20 may include a continuous outer wall 20a having a generally cylindrical configuration. In an embodiment, the continuous outer wall 20a may have a modified may have a conical configuration and, more particularly, the outer wall 20a may have an upwardly decreasing diameter. Stated another way, the primary body portion 20 configuration that is generally cylindrical except that it includes a flattened side wall 20b, the flattened side wall also referred to as a flattened area and may have a planar and smooth surface. In use, the flattened side wall 20b enables the primary body portion 20 to be positioned flush against a wall; for instance, a preferred usage of the trash receptacle 10 according to the present invention is for commercial or municipal use in which the trash receptacle 10 is likely to be positioned adjacent a municipal building or the like. Preferably, the primary body portion 20 and drip tray 30 may be constructed of plastic although rapid prototyping resin, polymers, or even aluminum may work.

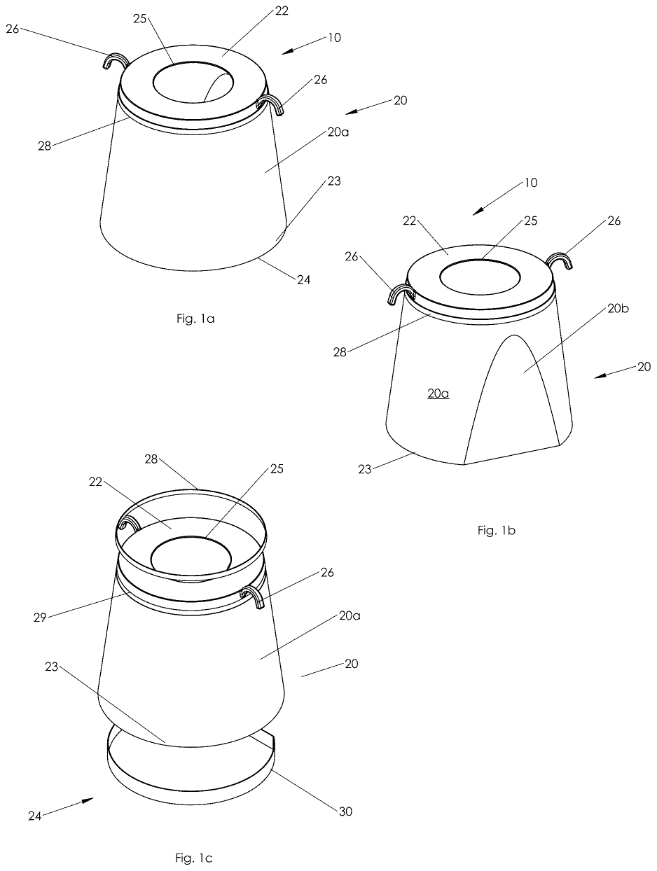

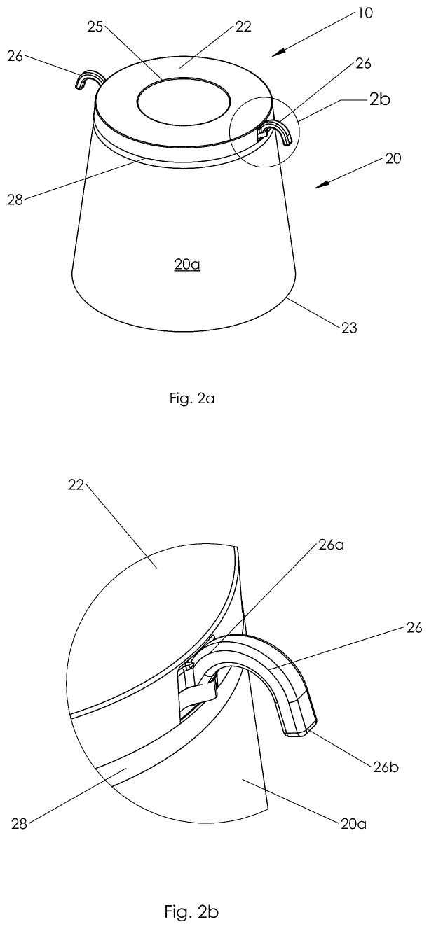

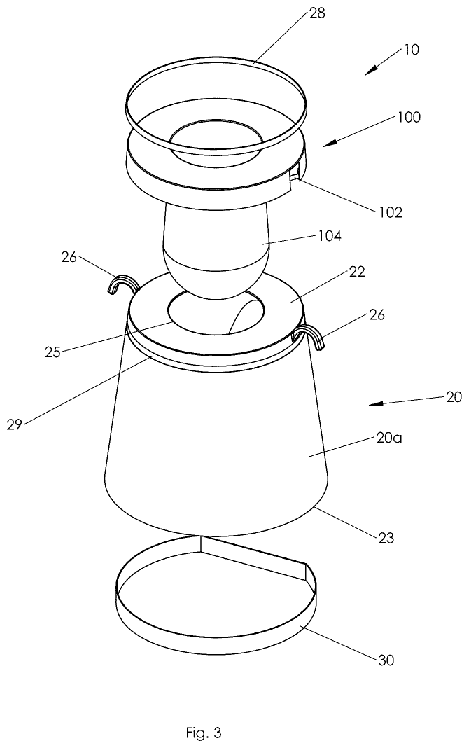

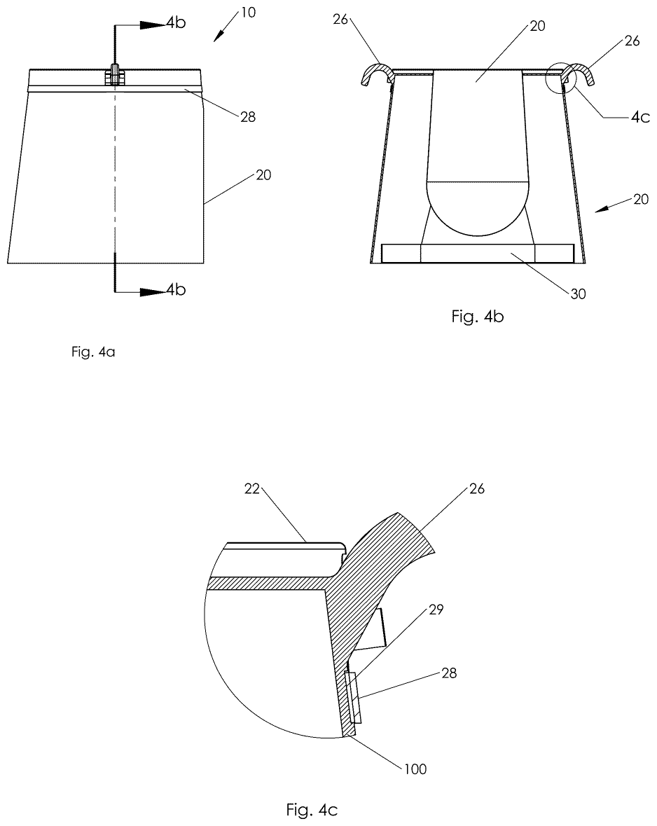

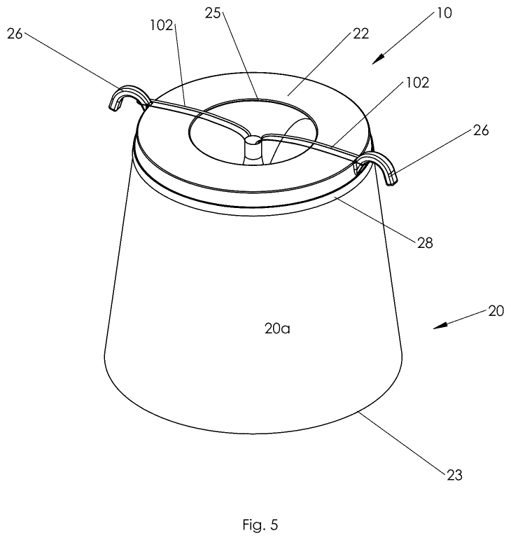

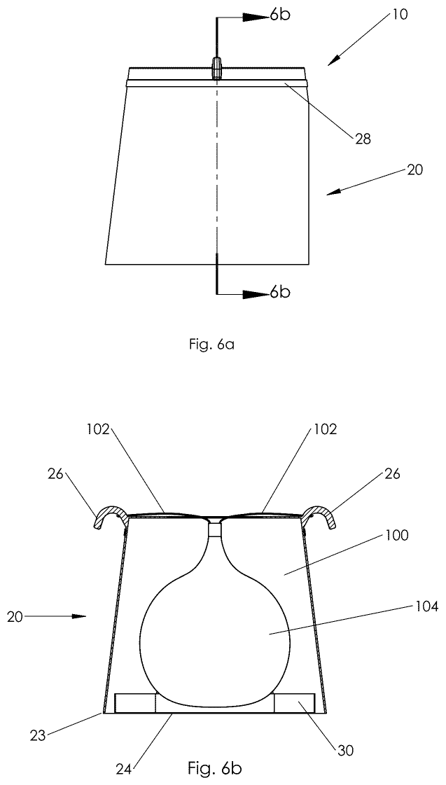

In an embodiment, the outer wall 20a of the primary body may include a top wall 22 having a diameter that is smaller than a diameter of an open bottom 24. The top wall 22 is generally planar and has a closed configuration except for an aperture 25 defined in the center thereof (FIG. 1a). Further, the outer wall 20a may include a lower peripheral edge 23 that defines the open bottom 24. The outer wall 20a and top wall 22, together define an open interior area.

In a critical aspect, the side wall 20a may define an inset groove 29 that is configured to receive the elastic band 28 in a nested configuration having a predetermined radius and being positioned generally proximate a peripheral edge of the top wall 22. Further, the primary body portion 20 may include an elastic band 28 having a continuous and circular structure that is configured for selective nesting in the groove 29. As its name implies, the elastic band 28 (such as a bungee cord) may be constructed of a resilient material that is capable of securing the material of a garbage bag 100 at least up to a predetermined level or range that the garbage bag may be pulled in a direction away from the elastic band 28. Examples of suitable elastic materials may include bungee material, an elastic waistband, resistance band, trampoline material, or even spring steel. As will be described later, a garbage bag 100 may be held down and secured to the groove 29 by the elastic band 28. Preferably, the elastic band 28 is specifically designed and manufactured to secure the garbage bag 100 up to a predetermined level of pulling force at which point the garbage bag will slip away from or out from under the elastic band 28 and be further deposited downwardly through the aperture 25 and interior area. This is intentional.

In another critical aspect, the primary body portion 20 may include a pair of oppositely disposed handles 26. More particularly, each handle 26 includes a first end 26a mounted to the peripheral edge of the top wall 22 and extends outwardly and laterally to a free end 26b, the handles 26 extending away from one another. In an embodiment, each handle 26 has an inverted U-shaped configuration. In use, the drawstrings 102 of the garbage bag 100 may have a looped configuration and may be received onto the pair of handles 26, respectively. This will be described in greater detail later where this relationship will cause the drawstrings 102 to tighten and close the main body portion 104 of the garbage bag 100 when the garbage bag is sufficiently filled with refuse and falls via gravity through the interior area and onto the drip tray 30.

In another aspect, the drip tray 30 may have a generally circular geometry and may have a concave configuration. In an embodiment, the drip tray 30 may include a truncated edge that is linear so as to be complementary to the shape of the outer wall 20a of the primary body portion 20. Accordingly, the drip tray 30 is suitable for catching liquids that may drip from the garbage bag 100. For instance, the garbage bag 100 may include refuse that is soaked in water, alcoholic beverages, sodas, water, or liquefied food items. It is understood that an overage of liquid is likely to leak through a garbage bag 100—especially if the bag has been damaged, ripped, or the like.

In use, a fresh and empty garbage bag 100 may be inserted into the garbage receptacle 10 such as by a municipal worker. More particularly, the drawstrings 102 of the garbage bag 100 may be received onto respected handles 26 and the main body portion 104 extended through the aperture 25 and suspended within the open interior area defined by the outer wall. Then, the elastic band 28 may be coupled to and stretched tight atop the inset groove 29 in a manner that captures and applies downward force to the continuous walls of the garbage bag 100 that has been stretched from the handles and through the aperture 25 into the open interior area. The trash receptacle 10 with installed garbage bag 100 is now ready to receive refuse throughout all or part of a day or week depending on the volume of garbage that is deposited therein. Of critical importance, it is understood that when a sufficient load of refuse has been deposited into the body of the garbage bag 100, the walls of the bag will be pulled and will slip out from under the elastic band 28 and the garbage bag 100 will fall via the forces of gravity onto the drip tray 30. This will automatically pull the drawstrings away from one another and tighten them so as to close the open top of the garbage bag 100.

It is understood that while certain forms of this invention have been illustrated and described, it is not limited thereto except insofar as such limitations are included in the following claims and allowable functional equivalents thereof.

What is claimed is:

1. A trash receptacle for securing a garbage bag, comprising:
a primary body portion having a generally inverted conical configuration defining a hollow interior area and having a top that defines an aperture;
a drip tray positioned adjacent an open bottom defined by the primary body portion, said drip tray being configured to receive drippings from the garbage bag;
a pair of handle members extending laterally outwardly from the top of the primary body portion and configured to receive opposed drawstrings of the garbage bag;
an elastic band removably coupled to a peripheral edge of the top of the primary body portion configured to secure the garbage bag to an exterior surface of the top until the body portion of the garbage bag becomes filled with refuse exceeding a predetermined weight, at which point the garbage bag is released by the elastic band and falls via gravity onto the drip tray, the fall of the garbage bag causing the drawstrings to engage and enclose the body portion of the garbage bag.

2. The trash receptacle of claim 1, wherein the elastic band is constructed from a resilient material selected from the group consisting of bungee material, elastic waistband, resistance band, trampoline material, and spring steel.

3. The trash receptacle of claim 1, wherein the primary body portion defines an inset groove proximate the top configured to receive the elastic band in a nested configuration.

4. The trash receptacle of claim 1, wherein the primary body portion further includes a flattened side wall having a planar and smooth surface configured to enable the receptacle to be positioned flush against a vertical surface.

5. The trash receptacle of claim 1, wherein the trash receptacle is made from a material selected from the group consisting of plastic, polymer, resin, and aluminum.

6. The trash receptacle of claim 1, wherein the elastic band is dimensioned to apply a predetermined level of downward force sufficient to retain the garbage bag until the weight of refuse exceeds a release threshold.

7. The trash receptacle of claim 1, wherein the aperture is centrally located in the top to allow vertical passage of the garbage bag into the hollow interior area.

8. The trash receptacle of claim 1, wherein the pair of handle members each have an inverted U-shaped configuration and are positioned such that engagement with the drawstrings causes automatic tightening of the drawstrings when the garbage bag falls through the aperture.

9. The trash receptacle of claim 1, wherein the drip tray has a circular and concave configuration and includes a truncated edge complementary to the shape of the primary body portion.

10. The trash receptacle of claim 1, wherein the drawstrings of the garbage bag are looped over the handles prior to stretching the garbage bag through the aperture and securing it with the elastic band.

11. A method for automatically sealing and depositing a garbage bag using a trash receptacle, comprising:
positioning a garbage bag into a trash receptacle having a primary body portion with a top defining an aperture and a hollow interior area;
looping opposed drawstrings of the garbage bag over a pair of handle members extending laterally from the top of the primary body portion;
extending a body portion of the garbage bag through the aperture into the hollow interior area;
securing an upper portion of the garbage bag to an exterior surface of the top using an elastic band removably coupled to a peripheral edge of the top;
filling the garbage bag with refuse until a predetermined weight is reached;
releasing the garbage bag from the elastic band as a result of the weight of the refuse;
allowing the garbage bag to fall via gravity onto a drip tray positioned adjacent an open bottom of the primary body portion; and
automatically drawing the drawstrings closed during the fall, thereby enclosing the body portion of the garbage bag.

12. The method of claim 11, further comprising selecting the elastic band from the group consisting of bungee material, elastic waistband, resistance band, trampoline material, and spring steel.

13. The method of claim 11, wherein the elastic band is received in an inset groove defined proximate the peripheral edge of the top.

14. The method of claim 11, wherein the trash receptacle is positioned flush against a vertical surface by aligning a flattened side wall of the primary body portion with the surface.

15. The method of claim 11, further comprising the step of collecting any drippings from the garbage bag in the drip tray having a concave configuration.

16. A trash receptacle for securing and closing a garbage bag, comprising:
a primary body portion having an inverted conical configuration and defining a hollow interior area, a top with an aperture, and an open bottom;
a drip tray disposed below the open bottom and configured to collect liquid from the garbage bag;
a pair of handle members mounted at the top and configured to receive opposed drawstrings of the garbage bag; and
an elastic band removably mounted to the top and configured to retain the garbage bag at the top until a predetermined threshold of weight is exceeded, whereby the garbage bag is released and falls onto the drip tray, thereby engaging and closing the drawstrings.

17. The trash receptacle of claim 16, wherein the handle members have an inverted U-shaped configuration.

18. The trash receptacle of claim 16, wherein the elastic band is positioned within an inset groove defined in the top.

19. The trash receptacle of claim 16, wherein the primary body portion further includes a flattened side wall to allow the trash receptacle to be placed flush against a surface.

20. The trash receptacle of claim 16, wherein the drip tray has a concave profile suitable for retaining liquid leakage from the garbage bag.
